(19) United States
(12) Patent Application Publication
(10) Pub. No.: US 2006/0043275 A1
(43) Pub. Date: Mar. 2, 2006

(54) Device and method for measuring surfaces on the internal walls of cylinders, using confocal microscopes

(76) Inventor: Mark A Weber, Moers (DE)

Correspondence Address: WILLIAM COLLARD;COLLARD & ROE, P.C., 1077 NORTHERN BOULEVARD, ROSLYN, NY, 11576, US

(21) Appl. No.: 10/534,395

(22) PCT Filed: Nov. 14, 2003
(86) PCT No.: PCT/DE03/03781

§ 371 Date: May 10, 2005

(30) Foreign Application Priority Data
Nov. 18, 2002 (DE) 102 53 891.3

(51) Int. Cl. H01J 40/14; H01J 3/14

(52) U.S. Cl. 250/234

(57) ABSTRACT

The invention relates to a method of computer-controlled confocal microscopy for producing three-dimensional surface images of the internal surfaces of cylinders in engine blocks. Said method uses a confocal microscope comprising a microscope body, a tube fixed to said body and equipped with a lens, in front of which is mounted a deflection optical system (2) with a horizontal translator (3).

The method described here serves for destruction-free 3D inspection of internal walls, particularly internal surfaces of cylinders, using computer-controlled confocal microscopes. There is a large market for this method, particularly in the automotive industry, since the internal surfaces of cylinders, in particular, prove to be critical elements for engine technology.

Until now, solutions for tactile methods and imaging microscopes have been known. The tactile methods have the disadvantage that they scan the surface and therefore work relatively slowly. Imaging microscopes have had the disadvantage, until now, that they cannot produce any three-dimensional data. Here, a method for three-dimensional measurement of internal walls of cylinders is described, which uses computer-controlled confocal microscopes.

The drawing shows:

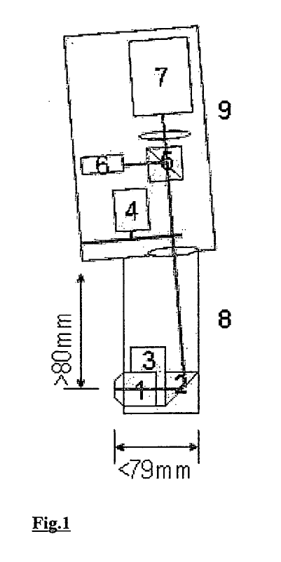

FIG. 1: fundamental sketch of the confocal microscope with deflection optics for observing internal walls of cylinders,

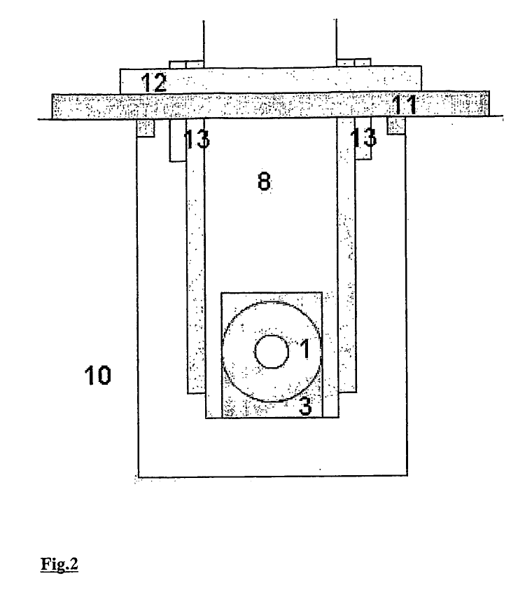

FIG. 2: fundamental sketch of the holder and adjustment device for installation of the confocal microscope in cylinders.

The invention presented here has the fundamental advantage that it is possible to carry out three-dimensional images of internal walls of cylinders, using refraction-limited lateral resolution, without destruction and in comparatively rapid manner. The tube of the confocal microscope can be sunk into the cylinder having a minimal diameter of 79 mm, with almost its entire length. Using this invention, confocal surface images can be taken in cylinders up to the maximal insertion depth of current 100 mm, without destruction.

A special guide prevents damage to the tube and allows vertical and horizontal adjustment of the observation range. By means of a rotational movement in the cylinder, almost the entire internal surface of the cylinder can be measured.

The microscope inserted into the cylinder is computer-controlled and can produce both video images and confocal images. Topographical parameters are produced from the raw data that are produced, using an evaluation unit that can also be provided with a remote control.

The development presented here is a special tube that replaces the microscope tube originally used, and a holder mechanism that attaches the confocal microscope to the cylinder and also serves as an adjustment unit. The structure of the base body remains essentially unchanged.

The invention accomplishes the task that has been set for it by means of the characteristics of claim 1.

In terms of device, the task is accomplished with the characteristics of claims 2 and 10.

FIG. 1 shows the beam path of a confocal microscope having a deflection optical system for observing internal surfaces of cylinders. The horizontal lens (1) is screwed into a horizontal positioning element (3), here a piezo setting element. The beam is deflected by means of a prism (2) having a mirrored hypotenuse. In order to save construction space, the reflection angle deviates from the perpendicular by 6 degrees. The tube (8) is attached to the microscope body (9) close to the Nipkow disk (4) that lies in the first image. The microscope body consists essentially of a motor-driven rotating Nipkow disk (4), a beam splitter (5), as well as a light source (6) and a CCD camera (7).

FIG. 2 shows a fundamental sketch of the holder and adjustment device for installation of the confocal microscope in cylinders. A clamping plate (11) is clamped into the cylinder (10) in the region of the upper 4 mm. This plate consists of two parts, which can be spread apart in order to clamp them. Both parts have projecting nipples, on the bottom, in each instance, in order to be able to engage into the cylinder. An adjustable adjustment plate (12) is attached on top, which can be used to focus. The tube (8) is inserted into and guided in two slide guides (13) that lie opposite one another; it can be locked in place after it has reached the correct insertion depth, by means of a clamping device. A horizontal piezo adjuster (3) is attached to the tube and holds a lens (1).

1. Method in computer-controlled confocal microscopy, for producing three-dimensional surface images of internal surfaces of cylinders in engine blocks, by using a confocal microscope having a microscope body, a tube attached to the latter and having a lens, which is preceded by a deflection optical system (2) having a horizontal translator (3).

2. Device for implementing the method according to claim 1, having a deflection optical system (2) located ahead of the lens (1).

3. Device according to claim 2, wherein the deflection optical system (2) consists of a reflection prism.

4. Device according to claim 2, wherein the deflection optical system (2) consists of a surface mirror.

5. Device according to claim 2, wherein the deflection optical system (2) deflects the beam by less than 90 degrees.

6. Device according to claim 2, wherein the lens (1) is a standard lens having an equalization length of 45 mm.

7. Device according to claim 2, wherein the lens (1) possesses an equalization length that is less than 45 mm.

8. Device according to claim 2, wherein the lens (1) can be moved by means of a piezo setting element (3).

9. Device according to claim 2, wherein the lens (1) can be moved by means of a stepper motor.

10. Device according to claim 2, having a device for attaching and adjusting the computer-controlled confocal microscope to be moved into cylinders in engine blocks, to measure the internal surfaces of the cylinders.

11. Device according to claim 10, wherein the attachment device possesses a clamping connection or screwed connection to the cylinder.

12. Device according to claim 10, wherein the microscope can be moved into the cylinder by means of a linear guide (13).

13. Device according to claim 10, wherein the microscope is adjustable and can be fixed in place with regard to the insertion depth, by means of the linear guide (13).

14. Device according to claim 10, wherein the attachment device or the adjustment device allows a rotation about the cylinder axis.

15. Device according to claim 10, wherein the attachment allows an adjustment of the distance between the lens and the internal surface of the cylinder, in other words focusing.
